(19) United States
(12) Patent Application Publication
(10) Pub. No.: US 2020/0080511 A1
(43) Pub. Date: Mar. 12, 2020

(54) A SEALING ARRANGEMENT FOR A ROTATABLE SHAFT OF A COMBUSTION ENGINE

(71) Applicant: Scania CV AB, Södertälje (SE)

(72) Inventors: Hans GÅNGFELDT, Älvsjö (SE); Stefan FORS, Tullinge (SE)

(73) Assignee: Scania CV AB, Södertälje (SE)

(21) Appl. No.: 16/462,587

(22) PCT Filed: Nov. 24, 2017
(86) PCT No.: PCT/SE2017/051166

§ 371 Date: May 21, 2019

(30) Foreign Application Priority Data
Nov. 28, 2016 (SE) 1651554-6

(51) Int. Cl. F02F 11/00; F16J 15/3276

(52) U.S. Cl. CPC F02F 11/007; B25B 27/0028; F16J 15/3276

(57) ABSTRACT

The present invention relates to a sealing arrangement for a rotatable shaft of a combustion engine. The rotatable shaft comprises a crankshaft journal, a crankshaft gear and a flywheel. The sealing arrangement comprises a sealing member configured to be arranged in an annular space between a surface defining an opening for said rotatable shaft through a stationary wall of the combustion engine and an outer periphery surface of the rotatable shaft. The sealing member comprises a radially outer portion to be fixedly arranged to the surface defining said opening. The crankshaft gear comprises a portion provided with a smooth outer periphery surface and that the sealing member comprises a radially inner portion comprising at least one sealing lip configured to sealingly abut against the outer periphery surface of the crankshaft gear.

### CROSS-REFERENCE TO RELATED APPLICATIONS

This application is a national stage application (filed under 35 § U.S.C. 371) of PCT/SE2017/051166, filed Nov. 24, 2017 of the same title, which, in turn, claims priority to Swedish Application No. 1651554-6 filed Nov. 28, 2016; the contents of each of which are hereby incorporated by reference.

### BACKGROUND TO THE INVENTION AND PRIOR ART

The present invention relates to a sealing arrangement for a rotatable shaft of a combustion engine.

A rotatable shaft of a combustion engine extends through an opening in a housing defining an inner space of the combustion engine. The annular space between an edge surface defining said opening in the housing and the rotatable shaft has to be sealed in order to prevent leakage of engine oil from the inner space of the combustion engine and ingress of contaminants from the surrounding into the combustion engine. A conventional sealing member for this purpose may comprise a radial outer portion, which is fixedly attached to the surface defining the opening in said housing and a radial inner portion comprising at least one sealing lip to be in contact with a surface of a flywheel portion extending through the opening. However, a flywheel is a cast component and the smoothness of its surface is not of highest quality. Consequently, the sealing properties of a conventional sealing arrangement is not exceptional. Furthermore, the flywheel obstructs the view of the sealing member during an assembly process of the flywheel. Consequently, it is difficult to move the flywheel to an intended mounting position in relation to the sealing member and it is not possible to check if the sealing lip of the sealing member abuts against the surface of the flywheel in a sealingly manner. Thus, the assembly process of the flywheel and the sealing member is relatively complicated to perform.

CN 203796438 U shows a sealing member preventing leakage of engine oil at an output of a crankshaft in a combustion engine. The sealing member comprises two sealing parts namely an outer sealing ring to be fixedly attached to a surface of a crankshaft housing and an inner sealing ring to be fixedly attached to an outer surface of a crankshaft gear. Thus, the sealing parts provides a rotary movement in relation to each other. Each sealing ring comprise a sealing lip abutting against an inner surface of the other sealing ring in order to prevent an oil flow through a space between said two sealing parts. This type of sealing member can be defined as cassette seal. Cassette seals are relatively expensive and the assembly process includes the steps to fixedly attach the respective sealing parts to the flywheel housing and the crankshaft gear.

### SUMMARY OF THE INVENTION

The object of the invention is to provide a sealing arrangement for a rotatable shaft of a combustion engine having an inexpensive design and a reliable function at the same time as it is easy to assemble.

These objects are achieved with the features defined in the claims. The sealing member comprises a radially inner portion provided with at least one sealing lip configured to abut an outer periphery smooth surface of the crankshaft gear. Usually, the crankshaft gear is in contrary to the flywheel manufactured by a material having a smooth surface. Thus, a sealing member provided with a sealing lip abutting against a surface of such a portion of the crankshaft gear has excellent sealing properties. The crankshaft gear is also usually manufactured of a more wear resistant material than the flywheel. This may result in an increased lifetime of the sealing. Furthermore, the above-mentioned design makes it possible to complete the assembly of the sealing member before it is time to assemble the flywheel. It is also possible to check that the sealing member has been assembled in a correct position before the flywheel is assembled. Thus, the assembly processes of the sealing member and the flywheel are performed in sequence and independently of each other. Consequently, the assembly process of the sealing arrangement will be relatively simple. Furthermore, the cost for the sealing arrangement is low since the sealing member is of an inexpensive type.

According to an embodiment of the present invention, the sealing lip is configured to abut against an outer periphery surface of the crankshaft gear with a resilient force. In order to provide an excellent sealing between a sealing lip and a surface, it is suitable that the sealing lip abuts against the surface with a force. The sealing lip can be manufactured by a material with elastic properties such that the sealing lip in a bent state abuts against the surface of the crankshaft gear with a resilient force. Alternatively, a spring member can be attached to the sealing lip.

According to an embodiment of the present invention, the crankshaft gear is manufactured of a hardened steel material. In order to transmit a torque in the combustion engine, the crankshaft gear has to be manufactured by a hardened material. Such a hardened material can be provided with a very smooth surface. In this case, it is possible to use a somewhat larger crankshaft gear with an added portion provided with said smooth outer periphery surface. Said outer periphery surface may be arranged at an axial distance from a toothed portion of the crankshaft gear. In this case, the crankshaft gear will be somewhat larger than a conventional crankshaft gear. The diameter of the added portion of the crankshaft gear may be smaller than the diameter of the toothed portion.

According to an embodiment of the present invention, the flywheel comprises a surface, which at least partly covers said annular space at one side of the sealing member. Such a design of the flywheel blocks the annular space and reduces the risk of oil leakage. Said surface of the flywheel may cover the entire annular space. Furthermore, such a part of the flywheel provides a protection for the sealing member.

According to an embodiment of the present invention, the sealing member comprises an outer sealing ring designed to be fixedly attached to the surface defining said opening by means of a pressing force. The outer sealing ring may have a somewhat larger diameter than the opening in a non-assembled state and some elastic properties such that it is possible to pushing the sealing member to a mounting position into said opening. In the mounting position, the outer sealing ring acts with a radially outwardly directed force on the surface defining maintaining the sealing member in a fixed position in the opening. The outer sealing ring may comprise a metal ring provided with a contact surface of a sealing material. The metal ring provides suitable resilient properties to the outer sealing ring and the sealing material ensures that there will be no leakage between the outer sealing ring and the surface defining the opening.

According to an embodiment of the present invention, the stationary wall is a part of a flywheel housing. A flywheel housing is usually used to enclose the flywheel and a shaft portion of the combustion engine provided on the flywheel side. Furthermore, it provide a wall section for an inner space of the combustion engine containing engine oil. The flywheel may be a cast iron component. A cast iron component has a relatively rough surface. Consequently, the sealing properties for a sealing member with a sealing lip abutting against a surface of a cast iron component is not exceptional.

According to an embodiment of the present invention, the crankshaft journal, the crankshaft gear and the flywheel are connected to each other by common bolts. The components may be provided with boltholes in corresponding position whereupon they a fixedly connected to each other by bolts. The bolts are applied in a last step of the assembly process of the sealing arrangement.

According to an embodiment of the present invention, the flywheel comprises a guide portion to be arranged in a radial gap between a surface defined by the crankshaft gear and a surface defined by the crankshaft journal. Such a design facilitates the movement of the flywheel to a predetermined mounting position in relation to the crankshaft gear and the crankshaft journal before they are fixedly connected to each other.

### BRIEF DESCRIPTION OF THE DRAWINGS

A preferred embodiment of the invention is described below by way of an example with reference to the attached drawings, on which:

FIG. 1 shows a sealing arrangement for a rotatable shaft of a combustion engine and

FIG. 2 shows the sealing arrangement in FIG. 1 more in detail.

### DETAILED DESCRIPTION OF A PREFERRED EMBODIMENT OF THE INVENTION

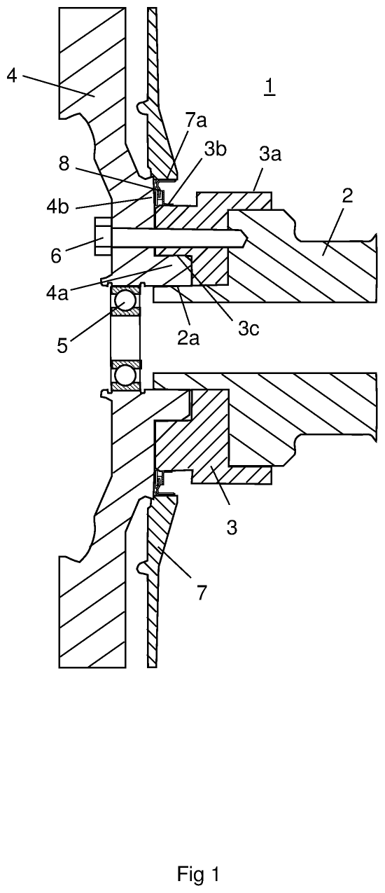

FIG. 1 shows a cross sectional view of a part of a rotatable shaft of a combustion engine 1. This part of the shaft comprises a crankshaft journal 2, a crankshaft gear 3 and a flywheel 4. The crankshaft journal 2 constitutes an outer end of a crankshaft. The crankshaft gear 3 comprises a toothed portion 3a to be in engagement with a not visible gear wheel in the combustion engine. In this case, the crankshaft gear 3 comprises a portion with a periphery surface 3b arranged at an axial distance from the toothed portion 3a. The crankshaft gear 3 is manufactured by a hardened steel material. The flywheel 4 is arranged on the outside of the combustion engine 1. The flywheel 4 is manufactured of cast iron. The flywheel 4 comprises an annular guide portion 4a configured to be arranged in an annular gap defined by a surface 3c of the crankshaft gear 3 and a surface 2a defined by the crankshaft journal 2.

The flywheel 4 is rotatably arranged by means of a bearing 5. The crankshaft journal 2, the crankshaft gear 3 and the flywheel 4 comprises bolt holes such they in an assembled state are connected to each other by means of common bolts 6. A flywheel housing 7 comprises a wall section limiting an inner space of the combustion engine 1. The wall section of the flywheel housing 7 comprises an opening defined by a circular edge surface 7a. The rotatable shaft extends through the opening in the flywheel housing 7. A sealing member 8 is arranged in an annular space formed between the edge surface 7a defining said opening and the periphery surface 3b of the crankshaft gear 3. The object of the sealing member 8 is to prevent leakage of oil from the combustion engine 1 to the surrounding via said annular space and to prevent ingress of impurities from the surrounding to the inner space of the combustion engine 1. The flywheel 4 comprises a surface 4b covering the annular space on an outside of the sealing member 8.

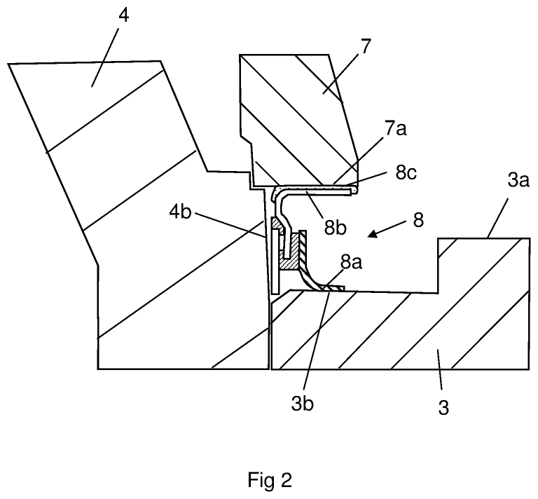

FIG. 2 shows the sealing member more in detail. The sealing member 8 comprises an outer sealing ring in the form of a metal ring 8b provided with a sealing material 8c. The sealing ring is designed such that it has a somewhat larger diameter in a non-assembled state than the opening defined by the edge surface 7a. Thus, the sealing member has to be pressed into the opening to a mounting position. In the assembled state, the outer sealing ring acts with a pressing force on the edge surface 7a such that the sealing member 8 will be fixedly arranged in the opening. The existence of the sealing material 8c ensures that no leakage will arise between the outer surface of the outer sealing ring and the edge surface 7a of the flywheel housing 7. The sealing member 8 comprises an inner sealing portion in the form of a sealing lip 8a. The sealing lip has elastic properties such that it in a bent state abuts against the outer periphery surface 3b of the crankshaft gear 3 with a resilient force. Since the crankshaft gear 3 is manufactured of a hardened steel material, it has a very smooth outer periphery surface 3b. Due to this fact, it is possible to provide a very tight sealing between the sealing lip 8a and the rotatable outer periphery surface 3b of the crankshaft gear 3.

Before the sealing member 8 is assembled, it is possible to assemble the crankshaft gear 3 in contact with associated gear wheels in the combustion engine 1 and attach the crankshaft housing 7 in an intended position. After that, the sealing member 8 is pressed into the annular space between the edge surface 7a of flywheel housing 7 and the outer periphery surface 3b of the crankshaft gear 3. In an assembled state, the outer sealing ring 8b, 8c acts with a radially outwardly pressing force on the edge surface 7a of the flywheel housing 7 such that the sealing member 8 is fixedly arranged in said annular space. Furthermore, the sealing lip 8a abuts with a resilient force against the outer periphery surface 3b of the crankshaft gear 3 in a bent state. There is nothing obstructing the view of the annular space during the assembly process of the sealing member 8, which facilitates the assembly process. Furthermore, it is easy to check if the sealing member 8 has been assembled in a correct manner in the annular space. After that, the flywheel 4 is to be assembled. The guide portion 4a of the flywheel 4 is moved into the annular gap formed by the surface 3b of the crankshaft gear 3 and the surface 2a of the crankshaft journal 2. Thus, the assembly process of the sealing member 8 and the flywheel 7 is performed in sequence in two separate steps. Consequently, it is simple to assemble the sealing member 8 and associated components 3, 4, 7.

The invention is in no way limited to the embodiment to which the drawing refers but may be varied freely within the scopes of the claims.

1. A sealing arrangement for a rotatable shaft of a combustion engine, wherein the rotatable shaft comprises a crankshaft journal, a crankshaft gear and a flywheel, wherein the sealing arrangement comprises a sealing member configured to be arranged in an annular space between a surface defining an opening for said rotatable shaft through a stationary wall of the combustion engine and an outer periphery surface of the rotatable shaft, wherein the sealing member comprises a radially outer portion to be fixedly arranged to the surface defining said opening, and wherein the crankshaft gear comprises a portion provided with a smooth outer periphery surface and that the sealing member comprises a radially inner portion comprising at least one sealing lip configured to sealingly abut against the outer periphery surface of the crankshaft gear.

2. A sealing arrangement according to claim 1, wherein the sealing lip is configured to abut against an outer periphery surface of the crankshaft gear with a resilient force.

3. A sealing arrangement according to claim 1, wherein the crankshaft gear is manufactured by a hardened steel material.

4. A sealing arrangement according to claim 1, wherein said outer periphery surface is arranged at an axial distance from a toothed portion of the crankshaft gear.

5. A sealing arrangement according to claim 1, wherein the flywheel comprises a surface which at least partly covers the annular space at one side of the sealing member.

6. A sealing arrangement according to claim 1, wherein the sealing member comprises an outer sealing ring designed to be fixedly attached to the surface defining said opening.

7. A sealing arrangement according to claim 6, wherein the outer sealing ring comprises a metal ring provided with a contact surface of a sealing material.

8. A sealing arrangement according to claim 1, wherein the stationary wall is a part of a flywheel housing.

9. A sealing arrangement according to claim 1, wherein the flywheel is a cast component manufactured of cast iron.

10. A sealing arrangement according to claim 1, wherein the crankshaft journal, the crankshaft gear and the flywheel are connected to each other by common bolts.

11. A sealing arrangement according to claim 1, wherein the flywheel comprises a guide portion to be arranged in a radial gap between a radial outer surface defined by the crankshaft gear an inner radial surface defined by the crankshaft journal.

12. A combustion engine comprising:
a rotatable shaft of a combustion engine, wherein the rotatable shaft comprises a crankshaft journal, a fly wheel, and a crankshaft gear, wherein the crankshaft gear comprises a portion provided with a smooth outer periphery surface; and
a sealing arrangement comprising a sealing member configured to be arranged in an annular space between a surface defining an opening for said rotatable shaft through a stationary wall of the combustion engine and an outer periphery surface of the rotatable shaft, wherein the sealing member comprises a radially outer portion to be fixedly arranged to the surface defining said opening, and wherein the sealing member comprises a radially inner portion comprising at least one sealing lip configured to sealingly abut against the outer periphery surface of the crankshaft gear.
